(19) United States
(12) Patent Application Publication
(10) Pub. No.: US 2013/0268503 A1
(43) Pub. Date: Oct. 10, 2013

(54) DATABASE NAVIGATION OF CHANGES AT COMMIT TIME

(71) Applicants: Damodara R. Budithi, Aurora, IL (US); Harpreet Singh, Bolingbrook, IL (US); Gopal Shankar, Carol Stream, IL (US); Lawrence Peter Casey, Annandale, NJ (US)

(72) Inventors: Damodara R. Budithi, Aurora, IL (US); Harpreet Singh, Bolingbrook, IL (US); Gopal Shankar, Carol Stream, IL (US); Lawrence Peter Casey, Annandale, NJ (US)

(21) Appl. No.: 13/441,018

(22) Filed: Apr. 6, 2012

(51) Int. Cl. G06F 17/30

(52) U.S. Cl. 707/703; 707/E17.005

(57) ABSTRACT

An exemplary database management device includes a database storage memory for storing database information. A user access memory at least temporarily stores information to be included in the database. At least a portion of the user access memory is configured to operate as a database manager that allows a user to indicate an intended change to the database information. The database manager places the intended change into the user access memory and determines whether the intended change complies with a criterion responsive to the user attempting to implement the intended change. The database manager makes the intended change to the database information in the database storage memory if the intended change complies with the criterion. The database manager provides an indication that the intended change will not be made to the database and the database storage memory if the intended change does not comply with the criterion.

### BACKGROUND

A database is a collection of information organized in a useful manner. Typical databases include records such as files, entries, fields, items or data. Database tables typically include a plurality of records.

Software application programs utilize information from a database for a selected purpose. From time to time it is necessary to modify the contents of a database by inserting new records, deleting records or altering records. It is critical to ensure that any changes to the database will not interfere with software application performance when accessing the altered information from the database. Additionally, it is necessary to ensure that changes to a database will not render other portions of the database unusable or unreliable.

A typical approach to monitoring changes to a database is to implement the changes and then perform an audit after the changes have been made to determine whether there is any negative effect resulting from the changes. If the audit reveals a problem, the database records that were changed have to be reconfigured or reset to the condition they were in prior to the change. This is an inefficient and sometimes difficult process.

### SUMMARY

An exemplary database management device includes a database storage memory for storing database information. A user access memory at least temporarily stores information to be included in the database. At least a portion of the user access memory is configured to operate as a database manager. The database manager allows a user to indicate an intended change to the database information. The database manager places the intended change into the user access memory. The database manager determines whether the intended change in the user access memory complies with at least one criterion for information included in the database responsive to the user attempting to implement the intended change to the database. The database manager makes the intended change to the database information in the database storage memory if the intended change complies with the criterion or provides an indication that the intended change will not be made to the database and the database storage memory if the intended change does not comply with the criterion.

An exemplary method of managing a database includes storing database information in a database storage memory. Information to be included in the database is temporarily stored in a user access memory. A database manager that is at least a portion of the user access memory is used for (i) placing an intended change to the database information into the user access memory, (ii) determining whether the intended change in the user access memory complies with at least one criterion for information included in the database responsive to an attempt to implement the intended change to the database, and (iii) making the intended change to the database information in the database storage memory if the intended change complies with the criterion or providing an indication that the intended change will not be made to the database in the database storage memory if the intended change does not comply with the criterion.

The various features and advantages of a disclosed example embodiment will become apparent to those skilled in the art from the following detailed description. The drawings that accompany the detailed description can be briefly described as follows.

### BRIEF DESCRIPTION OF THE DRAWINGS

FIG. 1 schematically illustrates an example database management device.

FIG. 2 schematically illustrates database Metadata useful with the example of FIG. 1.

FIG. 3 schematically illustrates selected portions of a transaction that includes an intended change to the database information.

FIG. 4 is a flowchart diagram summarizing an example transaction process.

FIG. 5 is a flowchart diagram summarizing the steps involved in log generation.

FIG. 6 is a flowchart diagram summarizing the transaction commit procedure.

FIG. 7 is a flowchart diagram summarizing an example procedure for a call back function (CBF).

FIG. 8 is a flowchart diagram summarizing the table iteration procedure.

### DETAILED DESCRIPTION

An exemplary database management device and method are disclosed that includes an at-commit confirmation of the acceptability of database changes before those changes are actually made to the database. A call back function, which is application-specific, includes at least one criterion that has to be satisfied for any change to be acceptable. The call back function navigates through all proposed changes within a current, active transaction. A transaction or database manager establishes a copy of the proposed changes in volatile memory and establishes a log of all of the changes to allow the call back function to navigate through the changes before the transaction is complete. The generated log points to old and new record image copies and a list of all operations of a transaction. The call back function is invoked within transaction-processing mode to provide better control over transaction management and database content. The disclosed approach avoids having to perform post-transaction audits and reversing changes to the database that should not have been made.

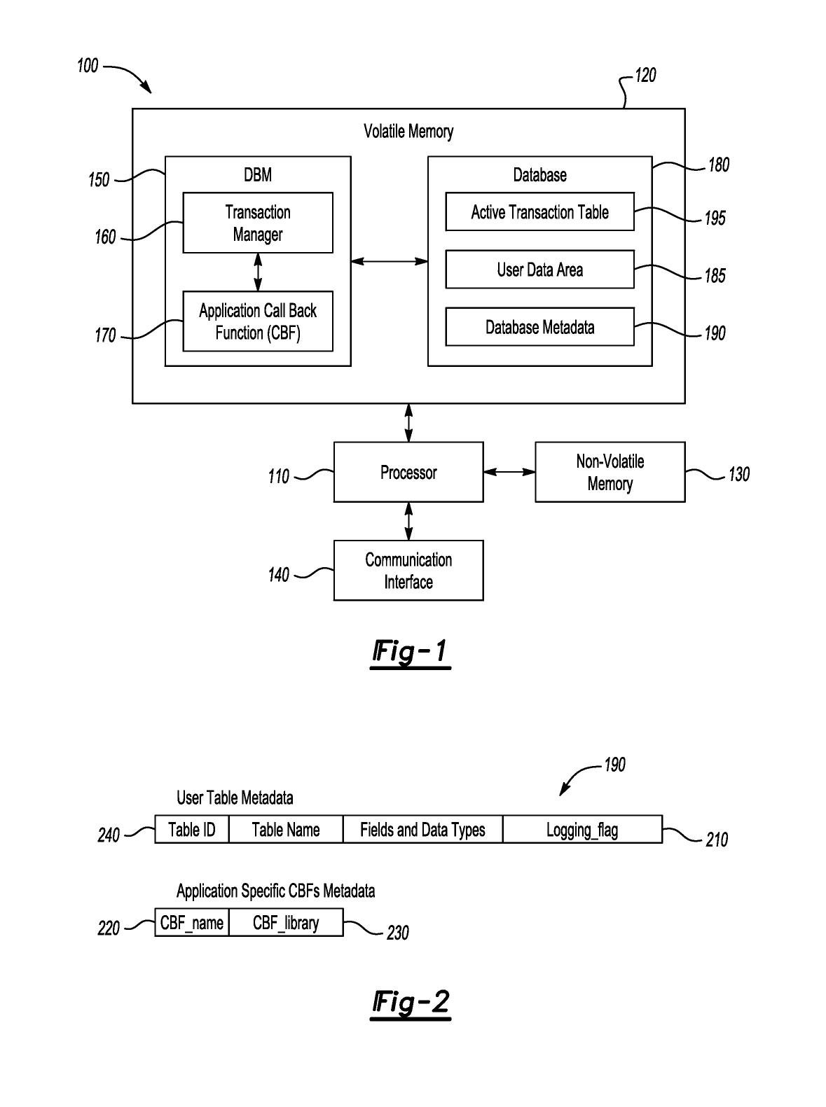

FIG. 1 schematically illustrates an example database management device 100. Various portions of the database management device 100 are schematically illustrated in FIG. 1 as distinct portions or components. Given this description, those skilled in the art will appreciate how computing components, software, firmware or a combination of these can be used for achieving the functionality of the schematically illustrated portions of the database management device 100.

The illustrated example includes a processor 110. One of the functions of the processor 110 in this example is to allow a transfer of information from a user access memory 120 to a database storage memory 130. Another function of the processor 110 is to allow for a user to have access to or make changes to a database stored in at least one of the user access memory 120 or the database storage memory 130. The processor 110 and the communication interface 140 may take a variety of forms. Those skilled in the art who have the benefit of this description will be able to configure a processor and communication interface to meet the needs of their particular situation.

In the illustrated example, the user access memory 120 is a volatile memory while the database storage memory is a non-volatile memory. In another example, the database storage memory 130 also comprises volatile memory. Example embodiments of the user access memory 120 and the database storage memory 130 comprise physical components such as hard disks, hard drives and processor random access memory. The user access memory 120 and the database storage memory 130 may be part of a single machine or may be located remote from each other, depending on the configuration of a particular embodiment.

A portion of the user access memory 120 is configured as a database manager (DBM) 150. In one example the DBM 150 comprises a software-based component. There are known ways of realizing a DBM within volatile memory of a database system. Given this description and known techniques, those skilled in the art will be able to realize a DBM that operates as the DBM 150 of the illustrated example.

The illustrated DBM 150 includes a transaction manager 160 that performs the various operations according to a desired transaction of a user. For example, a user communicates a desire to make a change to database information as part of a transaction. The transaction manager 160 is responsible for implementing the change according to the user's indications.

The DBM 150 includes a callback function (CBF) portion 170 that comprises at least one callback function that includes at least one criterion that has to be satisfied for a proposed change to database information to be implemented. The DBM 150 implements at least one CBF 170 prior to implementing a change to the database in the database storage memory 130. The CBF 170 includes a set of predetermined criteria, rules or both that have to be satisfied in order for a proposed change to the database to be acceptable. In some examples, a user configures the CBF 170 according to the predetermined criteria or rules that govern database content. The CBF may be specific to one type of transaction or may be applicable to various transaction types.

The illustrated example includes the CBF 170 for navigating through any proposed changes to the database before those changes are implemented. The rules or criteria utilized by the CBF 170 provide control over accepting or rejecting transaction changes to the database before those changes are made. The CBF 170 is operative while a transaction is active. In one example, the DBM 150 implements the CBF 170 at the time that the user attempts to commit the changes of the active transaction. In that sense, the CBF 170 is an at-commit feature for navigating proposed changes prior to completing the active transaction.

The user access memory 120 includes a database portion 180 for at least temporarily storing information regarding intended changes to be made to the database as part of a transaction. A user data area 185 stores the information or changes. A database Metadata portion 190 stores Metadata information about the user tables involved in a transaction such as the table name, the fields in the tables and their associated data types. The database portion 180 also includes an active transaction table 195 which stores information about database operations such as record insertion, modification and deletion.

FIG. 2 schematically illustrates an example database Metadata record from the database Metadata 190. A table ID 240 identifies the user table involved with a particular intended change to the database. A Boolean logging flag 210 allows for database application developers to configure desired user tables on which the logs should be maintained by the transaction manager 160. The DBM 150 provides a database definition interface to application developers through which user tables can be created, deleted and configured to enable or disable logging. A Metadata callback function name 220 indicates the function name that should be invoked by the transaction manager 160 during transaction commit A callback function library indicator 230 indicates the application software library name that contains the function body of the callback function name to be invoked. For example, application developers may use a data definition interface of the DBM 150 to store the callback function name 220 and the callback function library name 230 within the database Metadata.

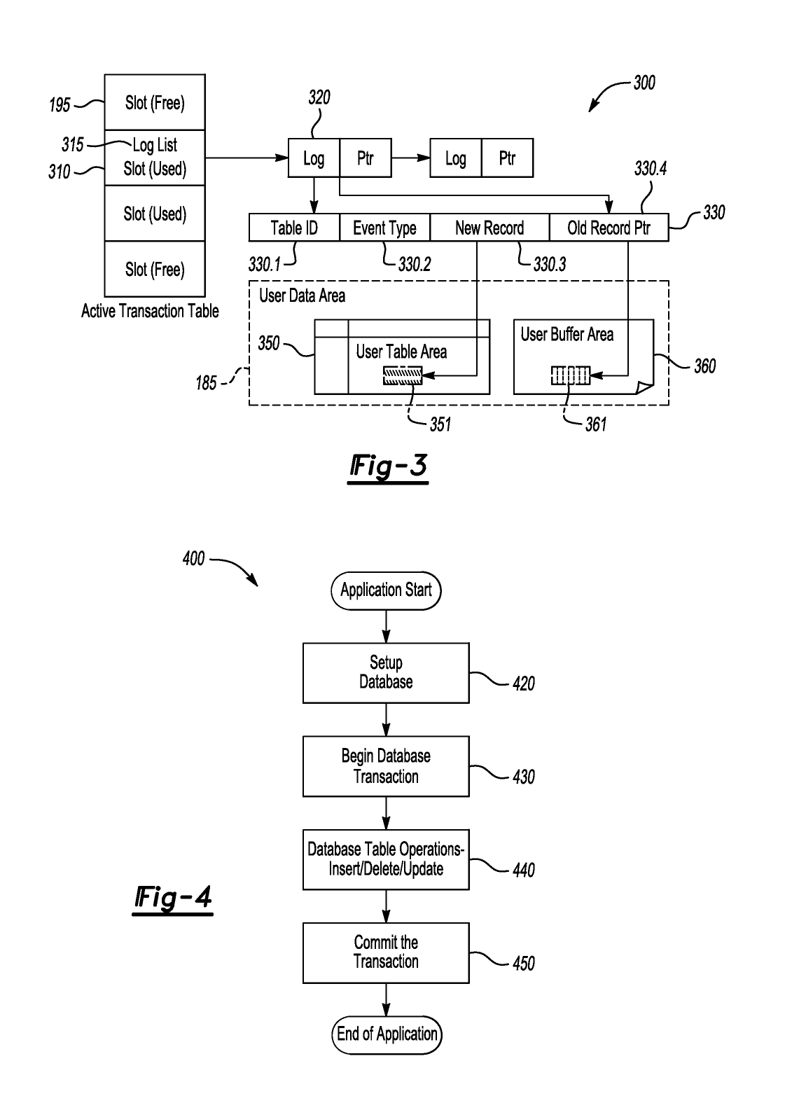

FIG. 3 schematically illustrates a portion of the processing of a transaction at 300. The active transaction table 195 includes a plurality of slots 310. Each slot 310 is a memory area that belongs to or is assigned to a single, particular transaction. In this example, a slot is marked as “free” to indicate that a new transaction can be started using that slot. A slot is marked as “used” to indicate that a transaction has begun but has not yet been committed or completed.

A used slot includes a log list 315 which acts as a pointer to a log 320, which is a memory area within the active transaction table 195. The log or logs of a transaction are generated by the transaction manager 160 in one example based on the logging flag 210 (FIG. 2) being set to “true” and stored in the database Metadata 190. In this example, one log is generated for each database operation. The log list 315 contains a listing of all logs generated by a particular transaction in the order in which the database operations are carried out by the application transaction.

At 330, an example configuration of the log 320 includes a table ID 330.1, an operation type or event type indicator at 330.2, a new record pointer at 330.3 and an old record pointer at 330.4. The table ID 330.1 indicates the table on which the operation was performed. The table ID 330.1 in this example is copied from the user table Metadata table ID 240 after performing the operation. The operation type 330.2 indicates the kind of operation to be carried out such as insert information, update information or delete information.

The new record pointer 330.3 indicates a memory pointer that points to the new record image found after the corresponding table operation is completed. For an insert operation, the new record pointer 330.3 points to a memory area within a user table area 350, which is part of the user data area 185 in the database portion 180 of the user access memory 120 (FIG. 1). For an update operation, the new record pointer 330.3 points to a memory area within the user table area 350 where the record is updated. For a delete operation, the new record pointer 330.3 points to a memory location in the user table area 350 that contains a null indication or zero, which indicates that there is no new memory record image.

The old record pointer 330.4 indicates a memory pointer that points to an old record image found after the table operation is complete. For an insert operation, the old record pointer 330.4 holds a null or zero value indicating that there is no old memory record image. For an update operation, the old record pointer 330.4 points to a user buffer area 360 that includes a memory area 361 where the old record image is copied and stored at the end of the update operation. In the case of a delete operation, the old record pointer 330.4 points to a memory area 361 within the user buffer area 360 where the old record image of the delete record is copied at the end of the delete operation.

FIG. 4 includes a flowchart diagram 400 that summarizes an example transaction process. After the application starts, the setup database step at 420 loads the DBM 150 and database 180 into the application process address space. This provides the application with direct access to operate on the database without any access to the database storage memory 130, which comprises non-volatile memory in some examples. The application requests that the transaction manager 160 begins a database transaction at 430. The application proceeds when the transaction manager 160 provides the application with a slot number from the active transaction table 195.

Using the provided slot number, database table operations are performed such as any combination of insert, update and delete table operations at 440. Once all of the operations have been performed, the application has provided an indication of any intended change or changes to the database. The application then commits the transaction at 450. Prior to or while committing the transaction, the CBF 170 navigates through all of the changes that are intended to be made to the database and verifies that each of them is acceptable according to predetermined criteria, rules or both governing the contents of the database. If all of the changes are acceptable, the transaction manager 160 implements the changes in the database information within the database storage memory 130. If any of the changes are not acceptable, the transaction manager 160 provides an indication that the transaction is denied and none of the intended changes are made to the database.

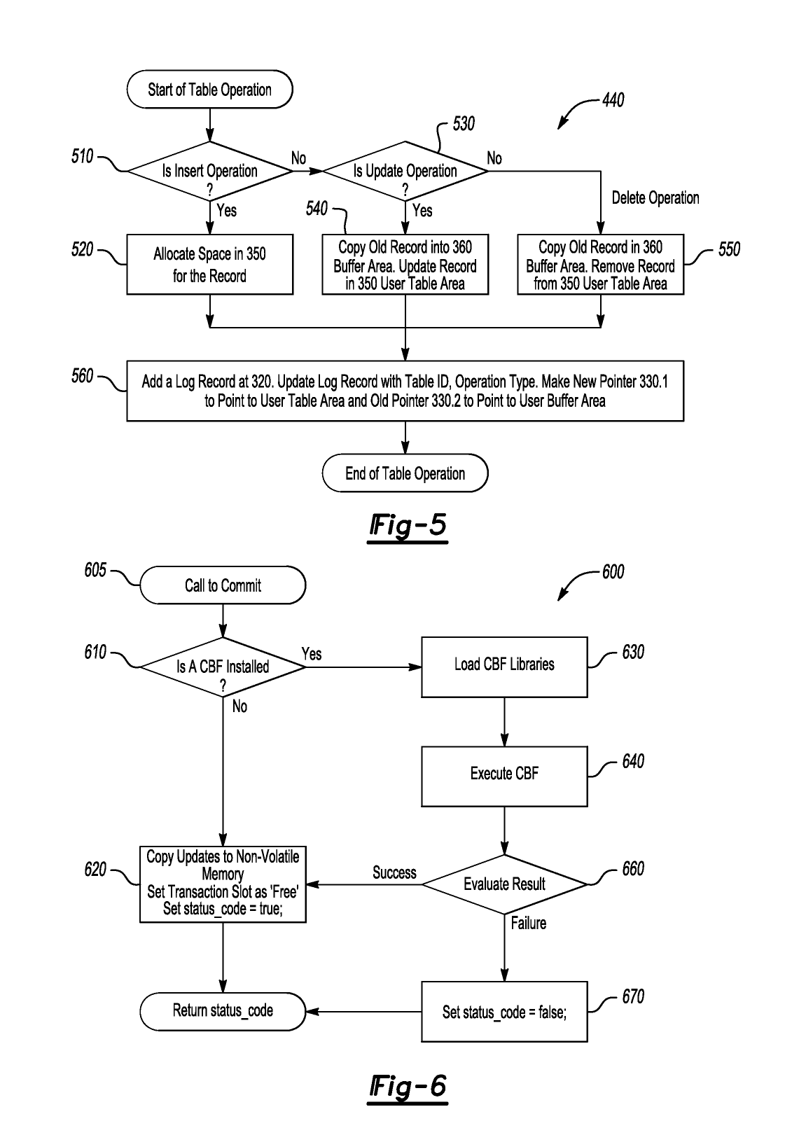

FIG. 5 is a flowchart diagram summarizing how the transaction manager 160 performs a table operation indicated at 440 in FIG. 4 according to one example. A determination is made at 510 whether the table operation is an insert operation. If it is, the transaction manager 160 allocates space at the new memory area 351 in the user table area 350 of the user data area 185. The allocated space is for storing the new record to be inserted.

If the operation is not an insert operation, a determination is made at 530 whether it is an update operation. If it is, new memory area 361 is allocated in the user buffer area 360 into which the old record image is copied. The record in the user table area 350 is updated at 540.

If the operation is not an insert or update operation, according to the example of FIG. 5, it is a delete operation. As shown at 550, for a delete operation a new memory area 361 in the user buffer area 360 is allocated and the delete record image is copied into that area 361. The record from the user table area 350 is deleted.

As shown at 560, at the end of the database operation the transaction manager 160 generates a log 320 that contains the table ID 330.1 of the table on which the operation was conducted. The log also includes an operation type 330.2 indicating the type of operation. A new record pointer 330.3 and an old record pointer 330.4 are also defined for the operation.

FIG. 5 shows an example of performing a single database operation. Application programs are useful for performing many database operations within a single transaction. The process schematically shown in FIG. 5 is used for each user table operation. In other words, each user table operation has a corresponding log that is generated and a list having corresponding information regarding those stored within the transaction slot. After all the operations of the transaction have been performed, it is possible to commit the transaction so that the changes are made to the database in a durable manner.

FIG. 6 is a flowchart diagram 600 that summarizes an example transaction commit procedure with a single CBF 170 installed. At the call to commit 605, the CBF 170 effectively takes control over the decision making process on whether to accept or reject the changes that occurred in the active transaction. The call to commit 605 corresponds to a user indicating that all desired or intended changes to the database have been indicated and that they are intended to be made permanent changes to the database in the database storage memory 130. At this point, none of those changes have been effected in the database storage memory 130. Instead, the information has been maintained in the database portion 180 of the user access memory 120 as described above.

In the example of FIG. 6, at 610, the transaction manager 160 determines whether a CBF 170 has been configured and installed. If not, at 620 the transaction manager 160 transfers the data to non-volatile memory 130, the transaction slot 310 is marked as “free” and a status code is set to “true.” In this example, the status code “true” corresponds to an application success message.

Provided that the CBF 170 has been configured, the transaction manager 160 implements the CBF 170 by loading the CBF library at 630, so that the CBF 170 can be invoked. The transaction manager 160 supplies the transaction slot number 310 as an argument and the CBF 170 uses the slot number to read the log list 315 associated with the transaction.

At step 640, the commit procedure executes or calls the CBF. The result of the CBF is evaluated at 660. If the CBF determines that any of the transaction operations fails to comply, the commit procedure sets the status code to “false” at 670, which provides an indication of a failure and the commit operation is cancelled. If all of the transaction operations comply with the corresponding rules or criteria, then the transaction manager 160 performs the step at 620 where the intended changes are made to the database in the database storage memory so that the changes are durable.

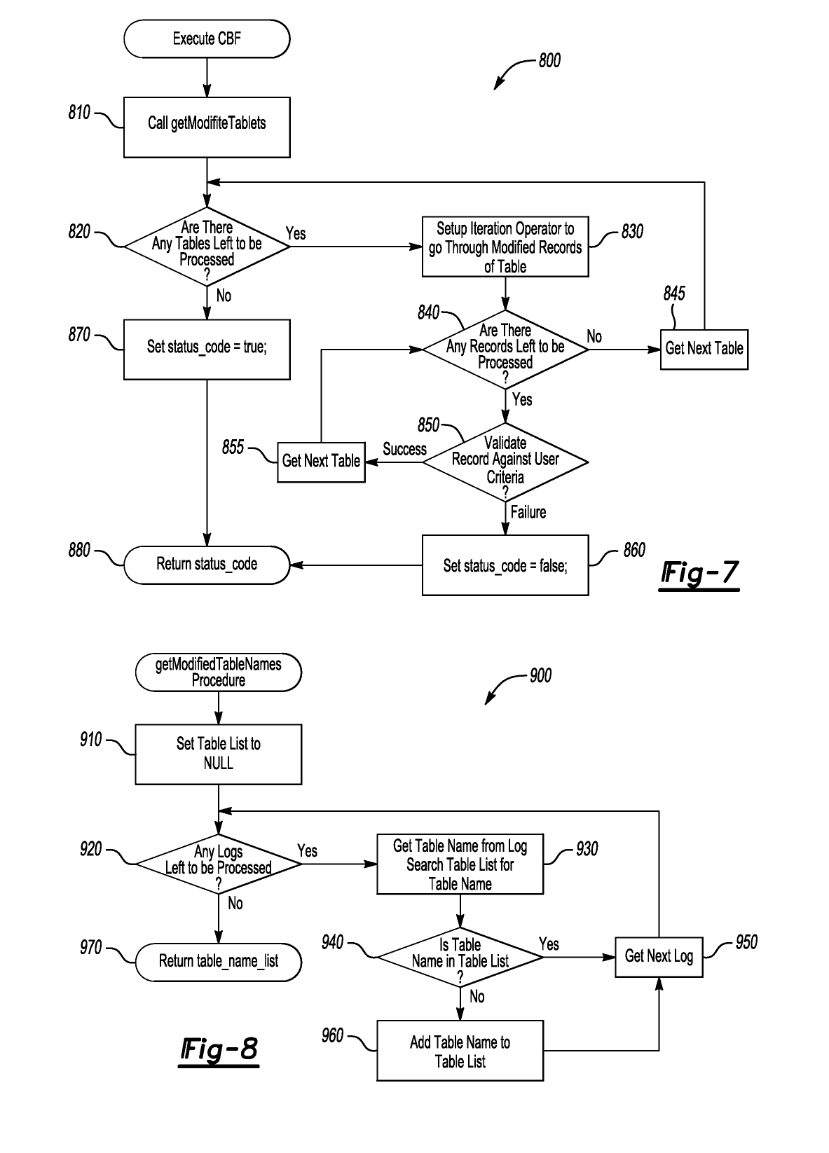

A CBF 170 in one example is a function call that is developed by the application programmer to make application specific decisions. FIG. 7 illustrates an example CBF procedure 800. The CBF uses the log list 310 to access the old and new record images of the particular operation type on a particular table of interest. The log 320 will indicate the location of the intended change to the database in the user data area 185 of the user access memory 120.

At 810 the CBF 170 calls the getModifiedTableName procedure. At 820 a decision is made whether any tables need to be processed. If there are none, then the status code is set to true at step 870 and the status code is returned to the commit function at 880. If there are tables to be processed, step 830 will set up an iteration operator to loop through the records in that table which were changed in the log. At step 840, a determination is made whether there are any more records to process. If there are no more records to be processed the procedure continues at step 845 where the next table is set to be processed and the procedure continues at step 820. Each record is validated at step 850. If the record matches the validation, the procedure continues by getting the next record to be validated at step 855. If the validation is not successful, the status code is set to false at step 860 and returned to the commit procedure at step 880.

FIG. 8 is a flowchart diagram 900 that summarizes the getModifiedTableNames procedure. At step 910 the table list is initialized to null. At 920 a decision is made whether there are any logs left. If so, the processing continues on to step 930 where the table name is retrieved from the log and the table name is searched for in the table list. At step 940, a decision is made whether the table name is in the table list. If the table name is not in the table list, it is added to the list at step 960, and the processing continues with the next log at 950. If at step 940, the table name is in the table list, the processing simply continues with the next log at step 950. When the end of the log list is found at step 920, the processing returns the table list at step 970.

The example at-commit call back function approach verifies that the changes to a database within an active transaction are acceptable before those changes are made to the database. Using the DBM 150 and the CBF 170 as described above facilitates managing transactions within an in-memory database management system.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

We claim:

1. A database management device, comprising:
a database storage memory for storing database information;
a user access memory for at least temporarily storing information to be included in the database, at least a portion of the user access memory being configured to operate as a database manager that
places an intended change to the database information into the user access memory,
determines whether the intended change in the user access memory complies with at least one criterion for information included in the database responsive to an attempt to implement the intended change to the database, and
makes the intended change to the database information in the database storage memory if the intended change complies with the criterion or provides an indication that the intended change will not be made to the database in the database storage memory if the intended change does not comply with the criterion.

2. The database management device of claim 1, wherein the database manager implements a call back function that includes the at least one criterion responsive to the attempt to implement the intended change in the database in the database storage memory.

3. The database management device of claim 2, wherein a transaction includes the intended change and the database manager implements the call back function while the transaction is active and before the intended change is made in the database in the database storage memory.

4. The database management device of claim 3, wherein the database manager implements the call back function as part of a commit operation of the active trans action.

5. The database management device of claim 3, wherein the transaction includes a plurality of intended changes and the database manager provides an indication that none of the plurality of intended changes will be made if any of the intended changes does not satisfy the at least one criterion.

6. The database management device of claim 1, wherein
the user access memory includes a user data area;
the database manager establishes a record of an operation corresponding to the intended change in the user data area; and
the database manager uses the record for determining whether the intended change satisfies the at least one criterion.

7. The database management device of claim 6, wherein the record in the user data area comprises an indication of at least each of
a table identifier,
an operation type for effecting the intended change,
a location of a new record containing an indication of the intended change, and
a location of an old record containing an indication of information in the database that will be changed as a result of the intended change.

8. The database management device of claim 7, wherein
there are a plurality of intended changes;
the database manager establishes a separate record for each of the intended changes; and
the database manager uses each of the records in an iterative process for determining that each of the intended changes satisfies the at least one criterion.

9. The database management device of claim 1, wherein the user access memory comprises volatile memory.

10. The database management device of claim 9, wherein the database storage memory comprises non-volatile memory.

11. A method of managing a database, comprising the steps of:
storing database information in a database storage memory;
at least temporarily storing information to be included in the database in a user access memory; and
using a database manager that is at least a portion of the user access memory for
placing an intended change to the database information into the user access memory,
determining whether the intended change in the user access memory complies with at least one criterion for information included in the database responsive to an attempt to implement the intended change to the database, and
making the intended change to the database information in the database storage memory if the intended change complies with the criterion or providing an indication that the intended change will not be made to the database in the database storage memory if the intended change does not comply with the criterion.

12. The method of claim 11, comprising using the database manager for implementing a call back function that includes the at least one criterion responsive to the attempt to implement the intended change in the database in the database storage memory.

13. The method of claim 12, comprising implementing the call back function while a transaction that includes the intended change is active and before the intended change is made in the database in the database storage memory.

14. The method of claim 13, comprising implementing the call back function as part of a commit operation of the active transaction.

15. The method of claim 13, comprising
providing an indication that none of a plurality of intended changes included in the transaction will be made if any of the intended changes does not satisfy the at least one criterion,
or
making all of the plurality of changes to the database in the database storage if all of the intended changes satisfy the at least one criterion.

16. The method of claim 11, comprising
establishing a record of an operation corresponding to the intended change in a user data area included in the user access memory; and
using the record for determining whether the intended change satisfies the at least one criterion.

17. The method of claim 16, wherein the record in the user data area comprises an indication of at least each of
a table identifier,
an operation type for effecting the intended change,
a location of a new record containing an indication of the intended change, and
a location of an old record containing an indication of information in the database that will be changed as a result of the intended change.

18. The method of claim 17, comprising
establishing a separate record for each of a plurality of intended changes; and
using each of the records in an iterative process for determining that each of the intended changes satisfies the at least one criterion.

19. The method of claim 11, wherein the user access memory comprises volatile memory.

20. The method of claim 19, wherein the database storage memory comprises non-volatile memory.
